(19) United States
(12) Patent Application Publication
(10) Pub. No.: US 2023/0399201 A1
(43) Pub. Date: Dec. 14, 2023

(54) LIFTING ASSEMBLY FOR GENERATOR ENCLOSURE

(71) Applicant: Kohler Co., Kohler, WI (US)

(72) Inventors: Brandon Mark Klos, West Bend, WI (US); Joseph Daniel Strackbein, Cascade, WI (US)

(21) Appl. No.: 18/208,533

(22) Filed: Jun. 12, 2023

Related U.S. Application Data
(60) Provisional application No. 63/351,986, filed on Jun. 14, 2022.

(51) Int. Cl. B66C 1/10; F16B 9/02

(52) U.S. Cl. CPC B66C 1/101; F16B 9/02

(57) ABSTRACT

Provided is a lifting assembly including a lift hook having a hook opening, a shaft attached to and extending away from the lift hook, at least one key attached to the shaft, and at least one keyhole. The at least one keyhole is configured receive the shaft and the at least one key when the key is in a predetermined position. The at least one keyhole is configured to prevent the shaft and the at least one key from moving through the at least one keyhole when the at least one key is in another position other than the predetermined position.

This application claims priority benefit of Provisional Application No. 63/351,986 (Docket No. 10222-22012A) filed Jun. 14, 2022, which is hereby incorporated by reference in its entirety.

### FIELD

The present application relates to a lifting assembly and methods for lifting a generator enclosure.

### BACKGROUND

A generator enclosure and a generator therein may need to be lifted during a variety of operations. For example, after the generator enclosure and generator have been manufactured, the generator enclosure may be lifted, for example, onto the bed of a semi-truck for shipment of the generator. When the generator reaches its destination, the generator enclosure may be lifted again for installation of the generator. In other operations, only a portion of a generator enclosure may need to be lifted. For example, only a roof panel of the generator enclosure may be lifted to perform maintenance on the generator or replace parts of the generator.

### BRIEF DESCRIPTION OF THE DRAWINGS

Exemplary embodiments of the present disclosure are described herein with reference to the following drawings, according to an exemplary embodiment.

FIG. 1 illustrates a perspective view of a generator enclosure including a lifting assembly according to an exemplary embodiment of the present disclosure.

FIG. 2 illustrates a side view of a generator enclosure and lifting assembly of FIG. 1.

FIG. 3 illustrates a perspective view of a lifting pin of a lifting assembly according to an exemplary embodiment of the present disclosure.

FIG. 4 illustrates a perspective view of a lock assembly of a lifting assembly according to an exemplary embodiment of the present disclosure.

FIG. 5 illustrates a perspective view of a lifting pin and a lock assembly when the lifting pin is in a position other than the predetermined position.

FIG. 6 illustrates another perspective view of a lifting pin and a lock assembly when the lifting pin is in a position other than the predetermined position.

FIG. 7 illustrates a partial cross-sectional view of a generator enclosure including a lifting assembly according to an exemplary embodiment of the present disclosure.

FIG. 8 illustrates a perspective view of a lifting pin and a lock assembly according to an exemplary embodiment of the present disclosure.

FIG. 9 illustrates a side perspective view of a lifting pin and a lock assembly according to an exemplary embodiment of the present disclosure.

FIG. 10 illustrates a top view of a lifting pin and a lock assembly according to an exemplary embodiment of the present disclosure

FIG. 11 illustrates a flow chart for a method of lifting a generator enclosure according to an exemplary embodiment of the present disclosure.

FIG. 12 illustrates a bottom brace of a lifting assembly according to an exemplary embodiment of the present disclosure.

FIG. 13 illustrates a perspective view of a generator enclosure according to an exemplary embodiment of the present disclosure.

### DETAILED DESCRIPTION

Before turning to the figures, which illustrate certain exemplary embodiments in detail, it should be understood that the present disclosure is not limited to the details and methodology set forth in the detailed description or illustrated in the figures. It should be understood that the terminology used herein is for the purpose of description only and should not be regarded as limiting.

Described herein are devices, systems, and methods for lifting a generator enclosure or a portion of a generator enclosure, for example, a roof panel of a generator enclosure. In some examples, the generator enclosure described herein may contain an engine and/or a generator (i.e., a genset). In other examples, the generator enclosure may not include a genset.

A lifting assembly according the to present disclosure may include one or more lifting pins and one or more locking assemblies attached to a generator enclosure. The lifting pins and the lock assemblies may be provided in equal numbers. The lifting pin may include a lift hook and a shaft attached to and extending away from the lift hook. The lifting pin may further include one or more keys attached to the shaft. The lock assembly may include one or more keyholes in the generator enclosure configured to receive the shaft and the key(s) (e.g., allow the shaft and the key(s) to move through the keyhole) when the key(s) are in a predetermined position (e.g., a specific radial position) and prevent the shaft and the key(s) from moving through the keyhole when the key(s) are in a position other than the predetermined position.

Accordingly, one or more lifting pins may be inserted into the keyhole(s) of the one or more lock assemblies. The one or more lifting pins may be inserted into the keyhole(s) of the one or more lock assemblies while the lifting pins are in the predetermined position. The one or more lifting pins may then be rotated to a position other than the predetermined position locking the one or more lifting pins within the one or more lock assemblies and the generator enclosure may be lifted using the lift hooks of the lifting pins.

The lifting assemblies and methods of lifting a generator enclosure disclosed herein allow the lifting points of both the generator enclosure and a roof panel of the generator enclosure to be consolidated near the top of the generator enclosure. The lifting assemblies of the present disclosure allow the lifting points of the generator enclosure to be moved from the side(s) of the generator enclosure to the top of the generator enclosure.

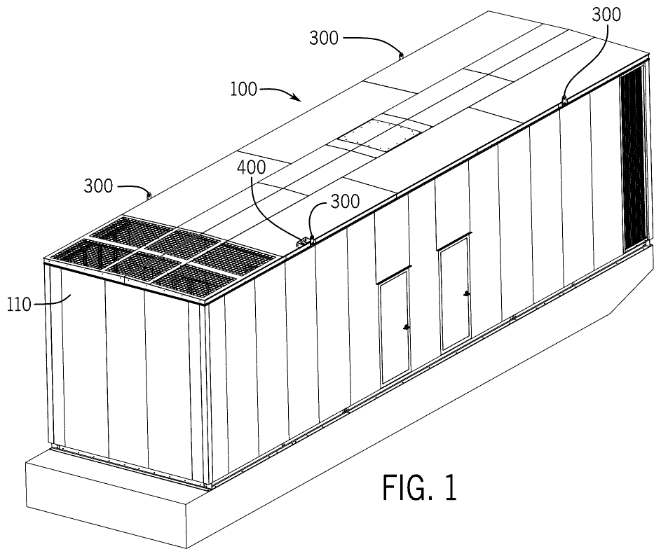

FIG. 1 illustrates a perspective view of a generator enclosure 100 and a lifting assembly according to an exemplary embodiment of the present disclosure. The lifting assembly, according to this embodiment includes four lifting pins 300 and four lock assemblies 400. As illustrated in FIG. 1, only one lock assembly 400 is visible within an outer surface 110 of the generator enclosure 100. The surface 110 of the generator enclosure may comprise a plurality of sheets or panels of a metal or metal alloy, for example, aluminum alloy. As illustrated in FIG. 1, each of the lifting pins 300 is disposed within a lock assembly 400 attached to the generator enclosure 100.

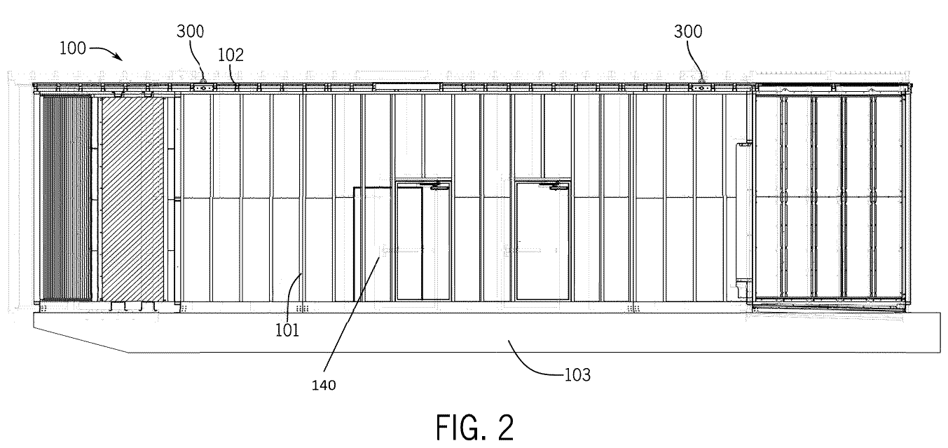

FIG. 2 illustrates a side view of a generator enclosure 100 including a lifting assembly according to an exemplary embodiment of the present disclosure. The generator enclosure 100 of FIG. 2 is illustrated without any sheets or panels comprising the outer surface 110 of the generator enclosure 100. In this embodiment, the generator enclosure 100 includes an engine and an alternator (i.e., a genset 140). The generator enclosure 100 may include a plurality of columns 101 and beams 102 forming the structure or frame of the generator enclosure. The one or more sheets or panels comprising the outer surface of the generator enclosure may be attached to the structure or frame of the generator enclosure formed by the plurality of columns and/or beams. In some examples, the lock assembly may be comprised of one or more beams 102 forming the structure of the generator enclosure 100. For example, one or more beams 102 forming the structure or frame of a roof panel of the generator enclosure 100 may also form the lock assembly. The plurality of columns 101 and beams 102 may be comprised of a metal or a metal alloy. In some examples, and as illustrated in FIG. 2, the generator enclosure 100 may be placed on top of a fuel tank 103 configured to store fuel for the genset 140.

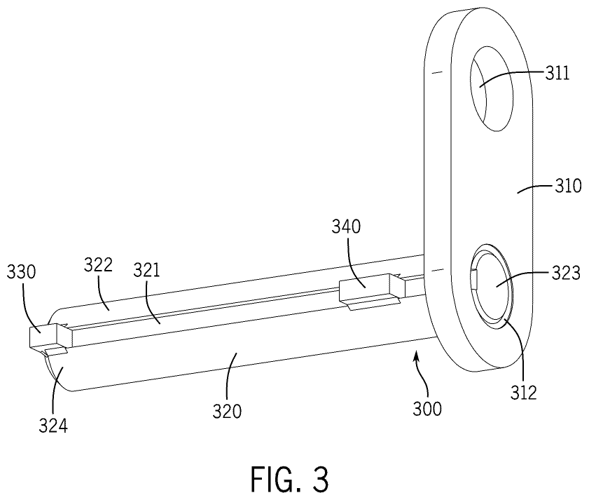

FIG. 3 illustrates a lifting pin 300 according to an exemplary embodiment of the present disclosure. The lifting pin 300 includes a lift hook 310, a shaft 320, and one or more keys, i.e., keys 330 and 340, attached to the shaft 320. The shaft 320 is attached to and extends away from the hook 310. In some examples, the lift hook 310 and the shaft 320 may be welded to one another. The one or more keys 330, 340 are attached to the shaft 320. In some examples, one of the keys 340 may also be attached to the lift hook 310. In some examples, the one or more keys 330, 340 may be welded to the shaft 320 and or the lift hook 310. In some examples, one or more of the lift hook 310, shaft 320, and/or keys 330, 340 may be manufactured as a single integral component.

The shape of the lift hook 310 may vary. In some examples, and as illustrated in FIG. 3, the lift hook 310 may have an obround shape. In other examples, the lift hook 310 may have a rectangular or another shape. The lift hook 310 may be comprised of a metal or a metal alloy. For example, the lift hook 310 may be comprised of aluminum alloy, cast iron, steel, or the like. The lift hook 310 includes a hook opening 311 extending through the lift hook 310. The shape of the hook opening 311 may vary. In some examples, as illustrated in FIG. 3, the hook opening 311 may have a circular shape. In other examples, the hook opening 311 may have an obround, rectangular, or any other suitable shape.

The hook opening 311 may be configured to receive an implement for lifting the generator enclosure. For example, the hook opening 311 may be configured to receive a hook (e.g., an eye hook, clevis hook, swivel hook, etc.), shackle (e.g., bow shackle, D shackle, etc.), chain, rope, or the like. The implement for lifting may extend through the hook opening 311 and may be secured to the hook opening 311. The implement for lifting may be coupled to a lifting machine, such as a crane, for lifting the generator enclosure.

The shaft 320 is attached to and extends away from the lift hook 310. In some examples, the lift hook 310 may including a shaft opening 312 configured to receive the shaft 320. An end of the shaft 320 (e.g., shaft first end 323) may be inserted into the shaft opening 312. The shaft 320 may be welded to the lift hook 310. In some examples, the shaft 320 may include a keyway 321. The keyway 321 may be formed in a shaft outer surface 322 and extend along the length of the shaft 320. The one or more keys 330, 340 may be disposed within the keyway 321 of the shaft 320. The shaft 320 may have a circular cross section including a keyway 321 formed therein. The shaft 320 may be comprised of a metal or metal alloy. For example, the shaft 320 may be comprised of aluminum alloy, cast iron, steel, or the like.

The one or more keys 330, 340 are attached to the shaft 320. The one or more keys 330, 340 may be attached to the shaft 320 so as to be disposed within the keyway 321. The one or more keys 330, 340 may be attached to the shaft 320 within the keyway 321 so as to protrude beyond a radius of the shaft. The number of keys 330, 340 attached to the shaft may vary. In some examples, as illustrated in FIG. 3, two keys 330, 340 may be attached to the shaft 320. In some examples, the one or more keys 330, 340 may be integrally formed with the shaft 320.

The first key 330 may be attached to the shaft at a shaft second end 324 (e.g., an end of the shaft 320 opposite the lift hook 310). The first key 330 may be configured to move through a keyhole in the lock assembly when the first key is in a predetermined position (e.g., a specific radial position). The first key 330 may be configured to prevent the shaft 320 and the first key 330 from moving through the keyhole when the first key 330 is in a position other than the predetermined position. The first key 330 may contact the lock assembly 400 preventing the lifting pin 300 from being withdrawn from the lock assembly 400 when the first key is in another position other than the predetermined position.

The second key 340 may be attached to the shaft 320 at the shaft first end 323 so as to be adjacent to the lift hook 310. The second key 340 may have a larger cross-sectional area than the first key 330. The second key 340 may be configured to abut a face of the generator enclosure after the first key has passed through the keyhole, preventing the first key 330 and the shaft 320 from extending further into the keyhole. The second key 340 may be attached (e.g., welded) to the shaft 320 and the lift hook 310.

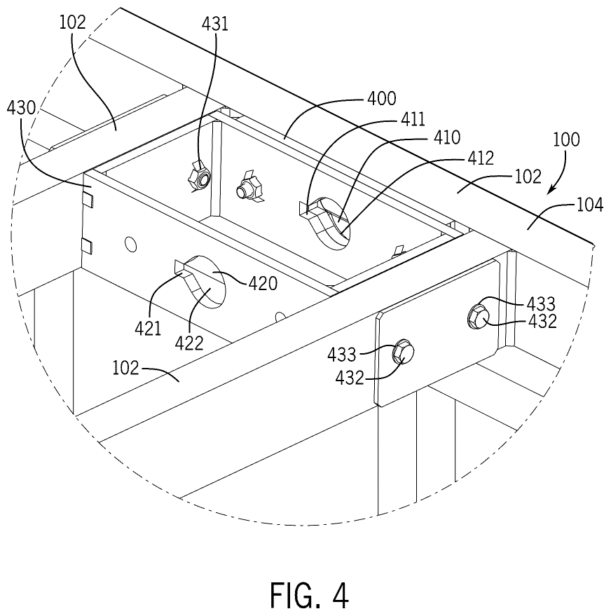

FIG. 4 illustrates a perspective view of a lock assembly 400 of a lifting assembly according to an exemplary embodiment of the present disclosure. In some examples, as illustrated in FIG. 4, the lock assembly may include a rectangular hollow section 430 having one or more keyholes (i.e., keyholes 410 and 420). In some examples, one or more components (e.g., beams, linear sections) may be attached (e.g., welded) together to form the rectangular hollow section 430. In these examples, the lock assembly 400 may be attached one or more beams 102 of the generator enclosure 100. For example, the lock assembly 400 may be attached to one or more beams 102 forming a roof panel 104 of the generator enclosure 100. In other examples, the lock assembly 400 may include one or more keyholes formed directly in one or more of the beams 102 comprising the structure or frame of the generator enclosure 100. In some examples, the one or more keyholes may be directly formed in roof panel 104 of the generator enclosure 100.

The rectangular hollow section 430 may be comprised of a metal or a metal alloy. For examples, the rectangular hollow section 430 may be comprised of aluminum alloy, cast iron, steel, or the like. The rectangular hollow section 430 may be attached to the generator enclosure 100 (e.g., beams 102) using a plurality of nuts 431 and bolts 432. The plurality of bolts 432 may extend through the generator enclosure 100, for example, through a beam 102 of the generator enclosure and through a bolt hole formed in the rectangular hollows section 430. A nut 431 may be screwed to each bolt, attaching, or securing the rectangular hollow section 430 to the generator enclosure 100. In some embodiments, a washer 433 may be disposed between each bolt 432 and the generator enclosure 100.

The lock assembly 400 includes at least one keyhole 410, 420 therein. Each of the at least one keyhole 410, 420 may be configured to receive at least one key 330, 340 and the shaft 320 (e.g., allow the shaft 320 and the key 330, 340 to move through the keyhole) when the at least one key 330, 340 is in a predetermined position. Each of the at least one keyhole 410, 420 may be configured to prevent the shaft 320 and the at least one key 330, 340 from moving through the at least one keyhole when the at least one key 330, 340 is in another position other than the predetermined position.

In some examples, the predetermined position of the at least one key 330, 340 may be a horizontal or substantially horizontal position on one side of the shaft 320. As illustrated in FIG. 4, each of the at least one keyhole 410, 420 may have a notch portion 411, 421 extending away from a circular portion 412, 422 of the keyhole 410, 420. Each of the at least one keyhole 410, 420 may be configured to receive the shaft 320 in the circular portion 412, 422 and the at least one key 330, 340 in the notch portion 411, 421. Accordingly, the location of the notch portion 411, 421 may correspond to (e.g., be the same as) the predetermined position of the at least one key.

The predetermined position of the at least one key 330, 340 and the location (e.g., radial location) of the notch portion 411, 421 may vary. In some examples the predetermined position of the at least one key 330, 340 and the location of the notch portion 411, 421 may be at 450 with respect to a horizontal or vertical axis. In other examples, the predetermined position of the at least one key 330, 340 and the notch portion 411, 421 may be a vertical position above or below the shaft 320 or the circular portion 412, 422, respectively.

In some examples, the at least one keyhole 410, 420 may have a shape corresponding to a cross section of the shaft and the at least one key 330, 340. The at least one keyhole 410, 420 may include a first keyhole 410 and a second keyhole 420. The first keyhole 410 and the second keyhole 420 may be disposed across from one another. In some examples, the first keyhole 410 and the second keyhole 420 may be disposed across from one another on parallel sides of the rectangular hollow section 430. A line through a central axis of the first keyhole 410 may be coincident with a line through a central axis of the second keyhole 420.

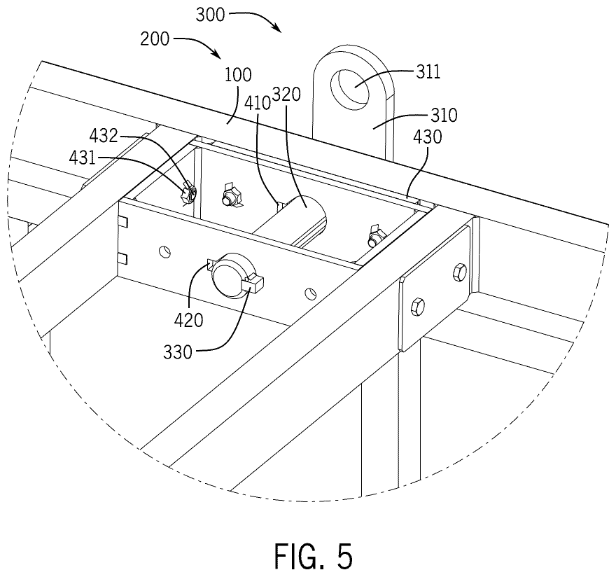

FIG. 5 illustrates a perspective view of a lifting assembly 200 including a lifting pin 300 and a lock assembly 400 when the lifting pin 300 is in a position other than the predetermined position. For example, FIG. 5 illustrates the lifting pin 300 in a locked position with respect to the lock assembly 400. As illustrated in FIG. 5, a lifting pin 300 has been inserted into the lock assembly 400, while the at least one key 330 was in the predetermined position and the lifting pin was rotated about a central axis of the shaft 320 to another position other than the predetermined position, locking the lifting pin 300 within the lock assembly 400.

In some examples, the lifting pin 300 may include two or more keys 330, 340 and only one of the keys, e.g., first key 330, may be inserted through the one or more keyholes 410, 420. A second key, e.g., second key 340, may be larger, for example, protruding further away from the shaft 320, and be configured to contact a surface 110 of the generator enclosure 100 (see FIG. 1), the lock assembly 400, or the roof panel 104 preventing the shaft 320 from extending further into the generator enclosure 100 and/or lock assembly 400.

As illustrated in FIG. 5, the lifting pin 300 has been rotated 180° about the central axis of the shaft 320 from the predetermined position to another position other than the predetermined position (e.g., a locked position). The angle of rotation between the predetermined position and another position other than the predetermined position may vary. For examples, the lifting pin 300 may be rotated 45°, 90°, 135°, or any other suitable angle of rotation from the predetermined position to another position other than the predetermined position. The lift hook 310 may be in a vertical orientation with the hook opening 311 located proximate to a top end of the lift hook 310 after the lifting pin 300 has been rotated to a position other than the predetermined position (e.g., a locked position).

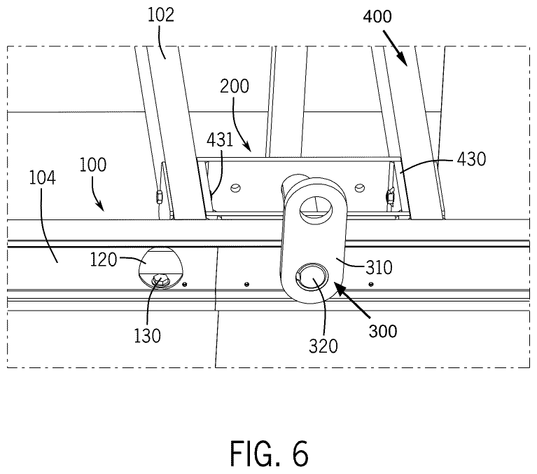

FIG. 6 illustrates a perspective view of a lifting assembly 200 including a lifting pin 300 and a lock assembly 400 when the lifting pin 300 is in a position other than the predetermined position. As illustrated in FIG. 6, the generator enclosure 100 may include a fastener opening 120 providing access to an enclosure fastener 130. The location of the fastener opening 120 may vary. For example, the fastener opening may be disposed in the roof panel 104 of the generator enclosure 100. In another example, the fastener opening 120 may be provided in a surface 110 of the generator enclosure 100. In some examples, the roof panel 104 may include a c-channel open to an exterior of the generator enclosure providing access to one or more enclosure fasteners 130.

The enclosure fastener 130 may be a bolt, a screw, or a rivet. The enclosure fastener 130 may be made of a metal or a metal alloy. The enclosure fastener 130 for example a bolt may secure or attach the roof panel 104 of the generator enclosure 100 to the remainder of the generator enclosure (i.e., the remainder of the columns 101 and beam 102 forming the generator enclosure 100). The fastener opening 120 may be configured to provide access to the enclosure fastener 130 so that the roof panel 104 may be attached to or detached from the remainder of the generator enclosure 100. For example, the roof panel 104 may be attached to or detached from the remainder of the generator enclosure 100 by screwing or unscrewing a bolt comprising the enclosure fastener 130. In some examples, the generator enclosure may include a plurality of fastener openings 120 and a plurality of enclosure fasteners 130 for securing the roof panel 104 to the remainder of the generator enclosure 100. In some examples, the enclosure fasteners 130 may be removed and the lifting assembly 200 may be configured to lift only the roof panel of the generator enclosure 100.

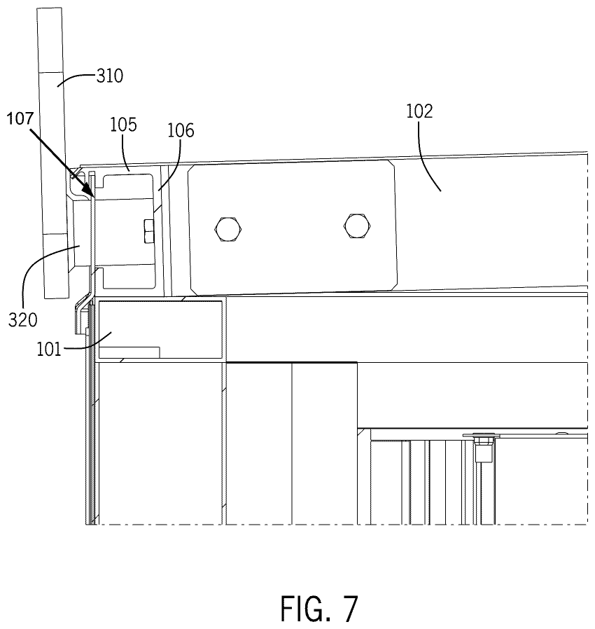

The surface 110 and/or the roof panel 104 of the generator enclosure 100 may include a lifting pin opening. The lifting pin opening may be configured to provide access to the one or more keyholes 410, 420 of the lock assembly 400. Accordingly, a shaft 320 and key 330, 340 of the lifting pin 300 may be inserted through the lifting pin opening into one or more keyholes in the lock assembly. In some examples, for example, when the roof panel includes a hollow structural beam 102, a lifting pin opening may be disposed in each of two or more walls of the beam 102 disposed across from one another. In other examples, as discussed below with respect to FIG. 7, the generator enclosure 100 may include a c-channel and only one lifting pin opening may be required to provide access to the lock assembly 400 and the one or more keyholes 410, 420.

In some examples, the lifting pin opening may have the same shape as the one or more keyholes 410, 420. In other examples, the lifting pin opening may have a shape that is larger than the one or more keyholes so that the shaft 320 and one or more keys 330, 340 of the lifting pin 300 may pass through the lifting pin opening.

FIG. 7 illustrates a partial cross-sectional view of a generator enclosure including a lock assembly 400 according to an exemplary embodiment of the present disclosure. In some examples, as illustrated in FIG. 7, one or more of the beams 102 comprising the generator enclosure may be a c-channel 105. The c-channel includes a connecting side 106 and an open side 107 disposed across from the connecting side 106. The c-channel 105 may further include a lift pin opening in the connecting side 106 of the c-channel 105. The lifting pin opening may be formed in the c-channel at a location corresponding to the at least one keyhole 410, 420. In some examples, a beam 102 or beams 102 around an upper perimeter (e.g., disposed between a side and a roof) of the generator enclosure may be a c-channel 105.

The open side 106 of the c-channel 105 may be configured to receive the shaft 320 and the at least one key 330, 340 of the lifting pin 300. The lifting pin 300 and the at least one key 330, 340 may be inserted through the open side of the c-channel and into the lifting pin opening disposed in the connecting side 106 of the c-channel. In some embodiments, the shaft 320, the first key 330, and the second key 340 may be inserted into the open side of the c-channel 105. The shaft 320 and the first key 330 may be inserted through the lift pin opening until the second key 340 abuts the connecting side 106 of the c-channel 105. After the second key 340 abuts the connecting side 106 of the c-channel, the lifting pin may be rotated, such that the first key 330 and the second key 240 are in a position other than the predetermined position.

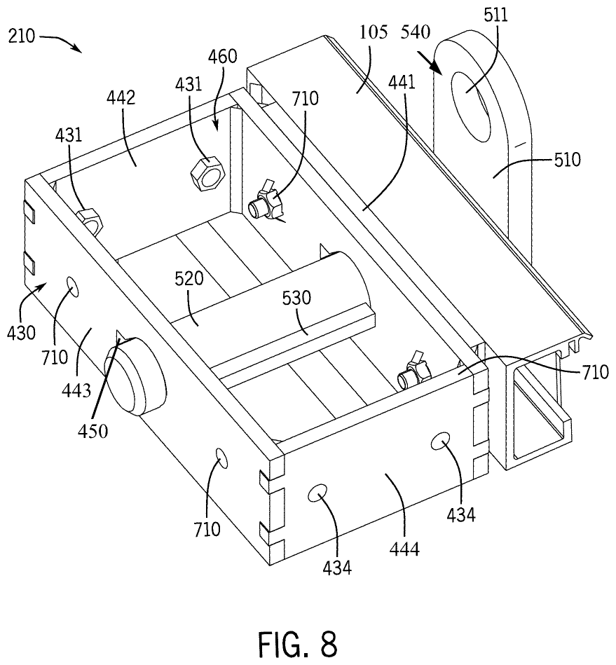

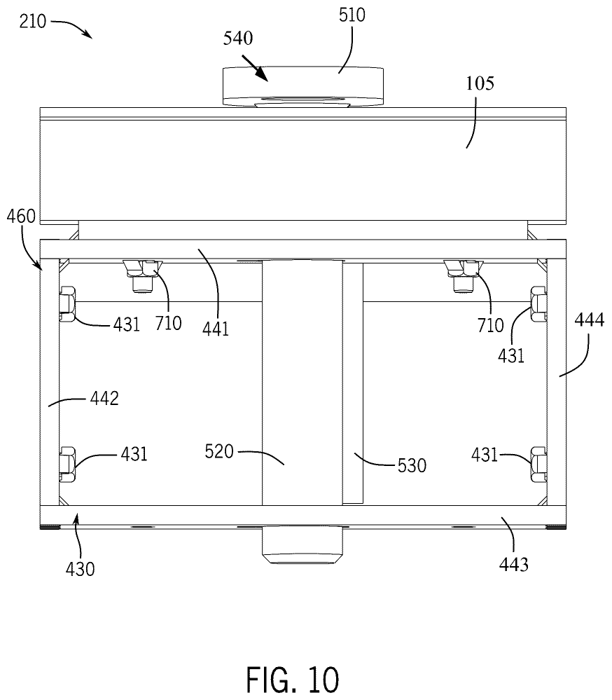

Referring generally to FIGS. 8-10, a lifting assembly 210 in accordance with another example of the present disclosure is illustrated. The lifting assembly 210 includes a lifting pin 540 including keyway 521 and a single key 530 disposed within the keyway 521 and a lock assembly 460 including a single keyhole. As illustrated in FIGS. 8-10, in some examples, a key 530 of the lifting pin 540 may be disposed within the lock assembly 400 when the key 530 is in a locked position or a position other than a predetermined radial position at which the key 530 aligns with a key hole of the lock assembly 460.

Referring to FIG. 8, a perspective view of the lifting assembly 210 in accordance with an example of the present disclosure is illustrated. As illustrated in FIG. 8, the lifting assembly 210 includes lock assembly 460. In some examples, the lock assembly 460 may include a rectangular hollow section 430. The rectangular hollow section 430 may include walls 441-444. The rectangular hollow sections may include a first set of parallel walls including walls 441 and 443 and a second set of parallel walls including walls 442 and 444. In some examples, the rectangular hollow section 430 may be a single integral component. In other examples, components including one or more the walls 441-444 may be attached or welded together to form the rectangular hollow section 430.

The rectangular hollow section 430 may be attached to a frame or structure of the generator enclosure (e.g., enclosure 100). Specifically, the rectangular hollow section 430 may be attached to one or more beams 102 and/or columns 101 of the generator enclosure 100. For example, a plurality of nuts and bolts (e.g., 431 and 432) may be used to attach the rectangular hollow section 430 to the frame or structure of the generator enclosure. Referring generally to FIGS. 8-10, in some examples, one or more nuts 431 may be attached to or integrally formed with one or more of the walls 441-444 of the lock assembly 460.

Returning to FIG. 8, a first wall 441 of the lock assembly 460 may be disposed adjacent and parallel to a side of the generator enclosure (e.g., 100). Specifically, as illustrated in FIG. 8, the first wall 441 may be disposed adjacent and parallel to an exterior beam (e.g., 102) of the structure or frame of the generator enclosure and/or the roof panel of the generator enclosure. As illustrated in FIG. 8, the first walls is disposed adjacent and parallel to c-channel 105 which is an outer beam of the frame of the generator enclosure and/or the roof panel of the generator enclosure. The third wall 443 of the lock assembly 460 may be disposed parallel to and across from the first wall 441. The lock assembly 400 may further include a second wall 442 and a fourth wall 444 perpendicular to the first wall 441 and the third wall 443. The second wall 442 and fourth wall 444 may each include holes 434 and/or nuts 431 configured to receive a fastener for coupling the rectangular hollow section 430 the frame or structure of the generator enclosure.

Referring generally to FIGS. 8-10, each of the first wall 441 and the third wall 443 may include an opening configured to receive a portion of the lifting pin 540. Specifically, the first wall 441 may include a keyhole (e.g., 410, 420) and the third wall 443 may include a retaining opening 450. The keyhole may be the same as the keyhole 410 described above with respect to FIG. 4. The keyhole may be configured to receive the shaft 520 and the key 530 when the lifting pin 300 is in the predetermined position with respect to the lock assembly 460. As described above the predetermined position may correspond to a radial or angular position of the lifting pin 540 at which the key 530 aligns with a notch portion (e.g., 421) of the keyhole. The retaining opening 450 may be configured to receive the shaft 520 of the lifting pin 540. Specifically, the retaining opening 450 may be a circular opening configured to receive only the shaft 520 and not the key 530 of the lifting pin 540.

Accordingly, the shaft 520 and the key 530 of the lifting pin 540 may be inserted through the keyhole in the first wall 441 and a portion of the shaft 520 may be inserted into the retaining opening 450. Additionally, the shaft 520 and key 530 may be inserted through a lifting pin opening formed in the c-channel 105. The lifting pin 540 may be inserted into the lock assembly 460 until the key 530 abuts the third wall 443 of the lock assembly 460. When the key 530 of the lifting pin abuts the third wall 443, the lifting pin 540 may be rotated (e.g., about a central axis of the shaft 520) from the predetermined position to another position (e.g., locked position) different than the predetermined positions. FIGS. 8-10 illustrate the lifting pin 540 in a position other than the predetermined position (e.g., a locked position). The lift hook 510 of the lifting pin may be oriented in a vertical or substantially vertical position when the lifting pin 540 is disposed in a locked position. After the lifting pin 540 has been rotated to the locked position the hook opening 511 disposed in the lift hook 510 may receive an implement for lifting the generator enclosure or the roof panel of the generator enclosure.

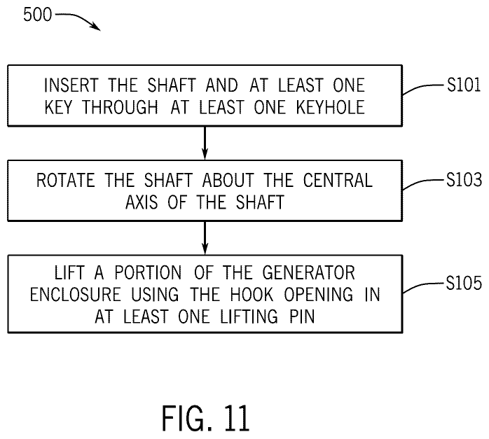

FIG. 11 illustrates a flow chart 500 for lifting a generator enclosure 100 according to an exemplary embodiment of the present disclosure. The various lifting assemblies disclosed herein may employ the flow chart of FIG. 8 for lifting a portion of a generator enclosure 100. Additional, fewer, or different acts may be provided. For ease of explanation, the flow chart 500 of FIG. 11 is explained below with reference to lifting assembly 200 as illustrated in FIGS. 5 and 6.

At act S101, the shaft 320 and at least one key 330, 340 attached to the shaft are inserted into the at least one keyhole 410, 420. In other words, a portion of the lifting pin 300 including a portion of the shaft 320 and the at least one key 330, 340 are inserted into the at least one keyhole 410, 420 of the lock assembly 400. The shaft 320 and the at least one key 330, 340 of the lifting pin 300 may be inserted into the at least one keyhole 410, 420 when the at least one key 330, 340 of the lifting pin 300 is in the predetermined position. The lifting pin 300 may be inserted into the at least on keyhole 410, 420 until a second key 340 abuts a surface 110 or a roof panel 104 of the generator enclosure 100. The second key 340 may abut a surface 110 or roof panel 104 after the first key has traveled through all of the keyholes in the lock assembly 400. In the case of the lifting assembly 200 of FIGS. 5 and 6, the second key 340 may abut the surface 110 or roof panel 104 after the first key 330 has traveled through both the first keyhole 410 and the second keyhole 420. In other examples, for example, with respect to the lifting assembly 210 of FIGS. 8-10, the lifting pin 540 may be inserted through the keyhole into the lock assembly 460 until the key 530 abuts the third wall 443 of the lock assembly 460.

At act S103, the shaft 320 of the lifting pin 300 is rotated about the central axis of the shaft 320. The lifting pin 300 may rotated about a central axis of the shaft 320 such that the first key 330 and the second key 340 are rotated from a specific radial position (e.g., a predetermined position) to another position other than the specific radial position (e.g., a locked position). The angle of rotation of the lifting pin may vary. For examples, in some examples the shaft 320 of the lifting pin 300 may be rotated 45°. In other examples, the shaft 320 may be rotated 90°. In yet other examples, the shaft 320 may be rotated 180° or any other suitable angle of rotation. In some examples, the lifting pin 300 (e.g., the shaft 320 of the lifting pin 300) may be rotated such that the lift hook 310 is in a vertical position. In some examples, the lifting pin 300 may be rotated such that lift hook 310 is in a vertical position with the hook opening 311 proximate to a top end of the lift hook 310. In some embodiments, the lifting pin 300 may be rotated such that the hook opening 311 is located above the roof panel 104 of the generator enclosure 100.

At act S105, a portion of the generator enclosure 100 is lifted using the hook opening 311 in the at least one lifting pin 300. The hook opening 311 is configured to receive an implement for lifting such as a hook (e.g., an eye hook, clevis hook, swivel hook, etc.), shackle (e.g., bow shackle, D shackle, etc.), chain, rope, or the like. The implement for lifting maybe attached to a lifting machine, such as a crane, for lifting a portion of the generator enclosure 100. The lifting pin 300, and more specifically, the shaft 320 of the lifting pin 300 may be configured to support the generator enclosure when the generator enclosure is lifted using the hook opening 311. In some examples, the hook opening 311 of the lifting pin 300 may be located above the roof panel 104 when a portion of the generator enclosure is lifted. In some examples, the portion of the generator enclosure to be lifted includes the entire generator enclosure 100. In other examples, the portion of the generator enclosure to be lifted includes only the roof panel 104 of the generator enclosure 100. Only the roof panel 104 of the generator enclosure 100 may be lifted when the one or more enclosure fasteners 130 attaching the roof panel 104 to the remaining portion of the generator enclosure are removed.

In some examples, a portion of the generator enclosure may be lifted using a plurality of lifting pins 300 and lock assemblies 400. The number of lifting pins 300 and lock assemblies 400 used to lift a portion of the generator enclosure may vary. For example, in some embodiments four lifting pins 300 and four lock assemblies 400 may be used to lift in a portion of the generator enclosure (e.g., the lift hook of four locking pins may be used to lift a portion of the generator enclosure). In another example, eight lifting pins 300 and eight lock assemblies 400 may be used to lift a portion of the generator enclosure. In yet another example, six lifting pins 300 and six lock assemblies 400 may be used to lift a portion of the generator enclosure. In some examples, the lifting pins 300 and lock assemblies may be equally spaced along a length of the generator enclosure.

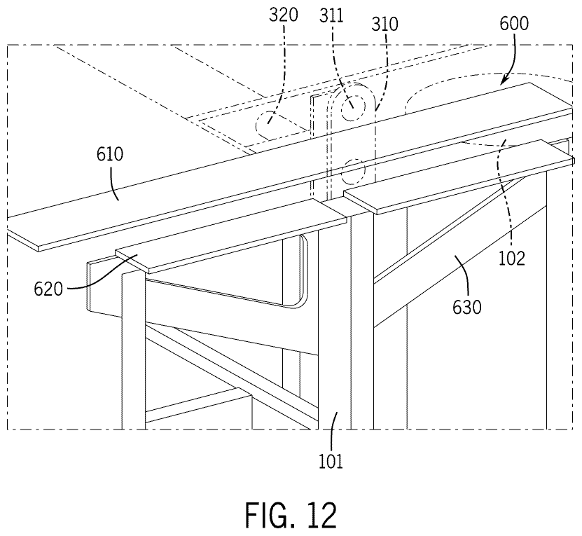

FIG. 12 illustrates a bottom brace 600 of a lifting assembly according to an exemplary embodiment of the present disclosure. In some embodiments, the lifting assembly 200 may further include one or more bottom braces 600. Each of the one or more bottom braces 600 may be attached to the generator enclosure 100 or 700 proximate to a lock assembly 400. For example, each of the one or more bottom braces 600 may be attached (e.g., welded, fastened) to a beam 102 and/or the lock assembly 400 of the generator enclosure 100.

The bottom brace 600 may include a top flange 610 attached to the top of a beam 102 of the generator enclosure and/or a top of the lock assembly 400. The bottom brace 600 may further include a bottom flange 620 and a web portion 630. The bottom flange 620 and the web portion 630 may have a substantially triangular shape. The bottom flange 620 may be attached to a bottom of a beam 102 of the generator enclosure and/or a bottom of the lock assembly 400 and form one side of the substantially triangular shape. The web portion 630 may extend downward from the top flange 610. The web portion 630 may include the other two sides of the triangular shape. The web portion 630 may have a smaller cross-sectional width than the top flange 610 and/or the bottom flange 620.

The bottom brace 600 may be comprised of metal or metal alloy. For example, the bottom brace 600 may be comprised of aluminum alloy, cast iron, steel, or the like. The bottom brace 600 may improve the structural rigidity of the generator enclosure 100. Specifically, the bottom brace 600 may distribute the load applied to the lock assembly to a larger area of the generator enclosure when a portion of the generator closure is lifted.

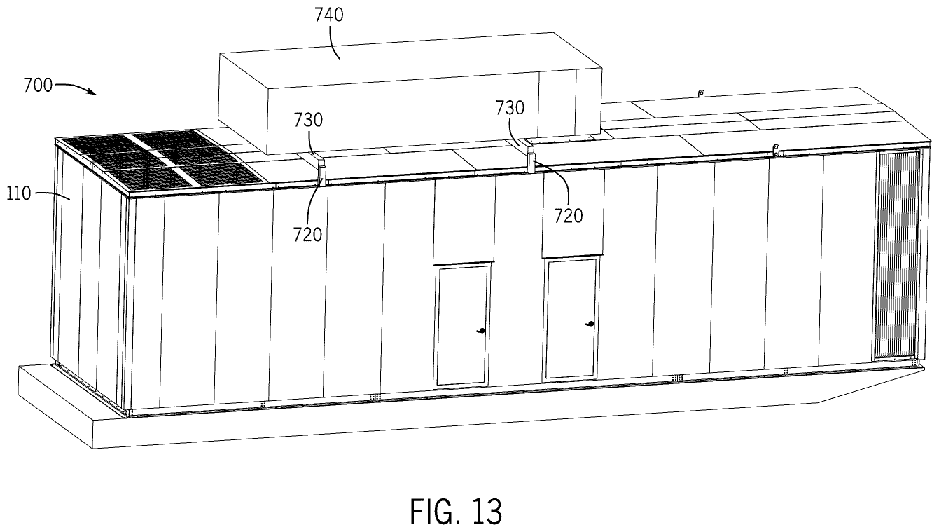

FIG. 13 illustrates a generator enclosure 700 including an exhaust treatment unit 740 in accordance with one example of the present disclosure. The exhaust treatment unit 740 may include one or more devices or systems configured to reduce harmful emissions produced during operation of the genset. For example, the exhaust treatment unit may include on or more catalysts (e.g., including platinum, palladium, and rhodium) that facilitate chemical reactions to convert harmful pollutants, such as carbon monoxide, nitrogen oxides, and unburned hydrocarbons into less harmful substances like carbon dioxide, nitrogen, and water vapor. The exhaust treatment unit 740 may be disposed above the generator enclosure 700.

Referring generally to FIG. 15, one or more mounting brackets 720 may be coupled or attached to a lock assembly (e.g., 460) of the generator enclosure 700. Specifically, each mounting bracket 720 may be configured to be attached to the lock assembly 460 after a lifting pin 540 has been removed from the lock assembly 460. A lifting pin 540 may be removed from the lock assembly 460 by rotating it to the predetermined position and withdrawing it from the lock assembly 460.

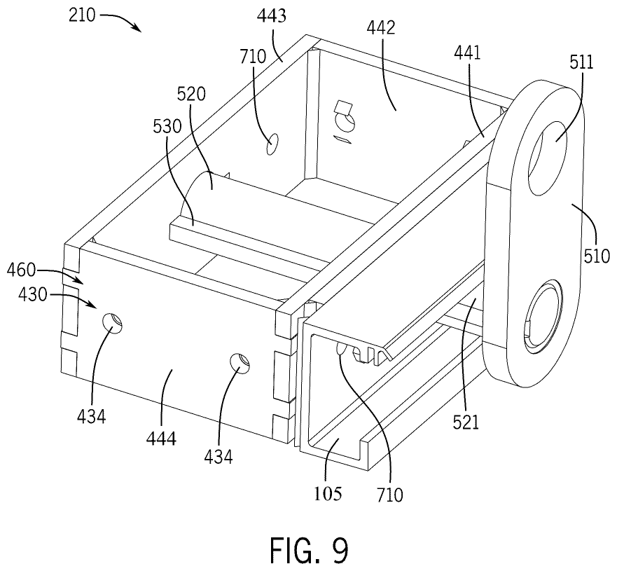

Referring to FIG. 8, in some examples, the lock assembly 460 may further include one or more mounting bracket holes 710. Each mounting bracket hole 710 may be configured to receive a fastener (e.g., bolt, screw, rivet, etc.) for coupling or attaching a mounting bracket 720 to the lock assembly 460. Still referring to FIG. 8, in some examples, both the first wall 441 and the third wall 443 may include a mounting bracket hole 710. Specifically, a fastener for coupling the mounting bracket 720 to the lock assembly 460 may extend through both a mounting hole 710 disposed in the first wall 441 and a corresponding mounting hole 710 disposed in the third wall 443 across from the first wall 441. Corresponding mounting holes 710 in the first wall 441 and the third wall me be concentric. In some examples, as illustrated in FIG. 8, a pair of corresponding mounting holes 710 formed in the first wall 441 and the second wall 443 may be disposed on each side of the keyhole. Referring to FIG. 9, in some examples the c-channel 105 comprising an exterior beam of the generator enclosure structure and/or roof panel may include a mounting hole 710. In these examples, a fastener may extend through the c-channel 105 in addition to lock assembly 460 when the mounting bracket 720 is coupled to the lock assembly 460. Returning to FIG. 15, two or more mounting brackets 720 may support a joist 730. In some examples, the joist 730 may extend between two mounting brackets 720 and each end of the joists may be attached or coupled to a mounting bracket 720. In some examples, as illustrated in FIG. 15, the joists 730 may extend between mounting brackets disposed on opposite sides of the generator enclosure 700. In other examples, a joist may extend between mounting brackets 720 disposed on the same side of the generator enclosure 700.

Still referring to FIG. 15, two or more joists 730 may support the exhaust treatment unit 740. The exhaust treatment unit 740 may be coupled or attached to the joists 730. For example, one or more fasteners may be used to attach or couple the exhaust treatment unit 740 to the joists 730. In another example, the exhaust treatment unit 740 may be welded to the joists 730. As illustrated in FIG. 15, the generator enclosure 700 includes four mounting brackets 720 and two joists 730; however, the present disclosure is not limited thereto and the generator enclosure 700 may include, for example, six mounting brackets 720 and three joists 730.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

When a component, element, device, or the like of the present disclosure is described as having a purpose or performing an operation, function, or the like, the component, device, or element should be considered herein as being “configured to” meet that purpose or to perform that operation or function.

What is claimed is:

1. A lifting assembly for a generator enclosure including an engine and an alternator, the lifting assembly comprising:
a lift hook including a hook opening;
a shaft attached to and extending away from the lift hook;
at least one key attached to the shaft; and
at least one keyhole configured to receive the shaft and the at least one key when the at least one key is in a predetermined position and prevent the shaft and the at least one key from moving through the at least one keyhole when the at least one key is in another position other than the predetermined position.

2. The lifting assembly of claim 1, wherein the shaft includes a keyway extending along the length of the shaft, and the at least one key is disposed within the keyway.

3. The lifting assembly of claim 1, further comprising:
a lock assembly having a hollow rectangular shape, the lock assembly including a first wall, the at least on keyhole disposed in the first wall and a second wall opposite the first wall, the second wall including a retaining opening configured to receive the shaft.

4. The lifting assembly of claim 3, wherein the at least one key is configured to abut the second wall after the at least one key has passed through the at least one keyhole, preventing the shaft from extending further into the lock assembly.

5. The lifting assembly of claim 3, wherein the lock assembly further includes one or more bracket mounting holes configured to receive a fastener for coupling a mounting bracket to the lock assembly, the mounting bracket configured to support an exhaust treatment unit.

6. The lifting assembly of claim 1, wherein the at least one key protrudes beyond a radius of the shaft.

7. The lifting assembly of claim 1, wherein the at least one key further comprises:
a first key disposed within a keyway extending along the length of the shaft and attached to the shaft at an end of the shaft opposite the lift hook; and
a second key disposed within the keyway and attached to the shaft adjacent to the lift hook, the second key being configured to abut a face of the generator enclosure after the first key has passed through the at least one keyhole, preventing the shaft from extending further into the at least one keyhole.

8. The lifting assembly of claim 1, wherein the shaft is configured to support the generator enclosure when the generator enclosure is lifted using the hook opening.

9. The lifting assembly of claim 1, wherein the predetermined position of the at least one key is a horizontal position located on one side of the shaft.

10. A lifting assembly for a generator enclosure, the lifting assembly comprising:
at least one lifting pin including a lift hook and a shaft attached to and extending away from the lift hook, the shaft including a keyway extending along the length of the shaft;
at least one key disposed in the keyway and attached the shaft; and
a generator enclosure including at least one lock assembly including at least on keyhole configured to receive the at least one key and the shaft when the at least one key is in a predetermined position and prevent the shaft and the at least one key from moving through the at least on keyhole when the at least one key is in another position other than the predetermined position.

11. The lifting assembly of claim 10, wherein the at least one lifting pin is configured to be rotated about a central axis of the shaft when the shaft and the at least one key of the at least one lifting pin are inserted through the at least one keyhole.

12. The lifting assembly of claim 10, wherein the at least one lifting pin is configured to support the generator enclosure when the generator enclosure is lifted using a hook opening in the at least one lifting pin.

13. The lifting assembly of claim 12, wherein six lifting pins and six lock assemblies are configured to support the generator enclosure when the generator enclosure is lifted.

14. The lifting assembly of claim 10, wherein the at least on keyhole has a shape corresponding to a cross section of the shaft and the at least one key.

15. A method of lifting a portion of a generator enclosure with a lifting assembly, the lifting assembly including at least one lifting pin having a lift hook including a hook opening, a shaft attached to and extending away from the lift hook, at least one key attached to the shaft protruding beyond a radius of the shaft, and a generator enclosure including at least one keyhole configured to allow the at least one key and the shaft to move through the at least one keyhole when the at least one key is in a single, specific radial position and prevent the shaft and the at least one key from moving through the at least on keyhole when the at least one key is in a radial position other than the specific radial position, the method comprising:
inserting the shaft and the at least one key through the at least one keyhole while the key is in the specific radial position;
rotating the shaft about a central axis of the shaft so that the at least one key is in a radial position other than the specific radial position; and
lifting a portion of the generator enclosure using the hook opening in the at least one lifting pin.

16. The method of claim 15, wherein the portion of the generator enclosure includes an entire generator enclosure.

17. The method of claim 15, wherein the at least one keyhole in the generator enclosure is formed in a roof panel of the generator enclosure, and wherein the portion of the generator enclosure includes the roof panel of the generator enclosure.

18. The method of claim 15, wherein the lifting the portion of the generator enclosure includes lifting the portion of the generator enclosure using the lift hook disposed in six lifting pins.

19. The method of claim 15, wherein the rotating the shaft comprises rotating the shaft of the at least one lifting pin 180 degrees.

20. The method of claim 15, wherein the hook opening of the lifting pin is located above a roof panel of the generator enclosure when a portion of the generator enclosure is lifted.
